(19) United States
(12) Patent Application Publication
(10) Pub. No.: US 2014/0247290 A1
(43) Pub. Date: Sep. 4, 2014

(54) CONTROL APPARATUS, ELECTRO-OPTICAL APPARATUS, ELECTRONIC DEVICE, AND CONTROL METHOD

(71) Applicant: SEIKO EPSON CORPORATION, Tokyo (JP)

(72) Inventors: Atsushi MIYAZAKI, Suwa-shi (JP); Toshimichi YAMADA, Fujimi-machi (JP); Kota MUTO, Suwa-shi (JP); Hiroaki KANAMORI, Suwa-shi (JP)

(73) Assignee: SEIKO EPSON CORPORATION, Tokyo (JP)

(21) Appl. No.: 14/193,942

(22) Filed: Feb. 28, 2014

(30) Foreign Application Priority Data
Mar. 4, 2013 (JP) 2013-041813

(51) Int. Cl. G09G 3/20; G09G 3/34

(52) U.S. Cl. CPC G09G 3/2007; G09G 3/344
USPC 345/690; 345/107

(57) ABSTRACT

In order to achieve a desired gray level in an optical state of a bi-stable display element, voltage application is carried out so that the gray level follows a predetermined gray level change loop through a erasing period, a reset period, and a write period.

### BACKGROUND

1. Technical Field

The present invention relates to techniques for controlling the driving of bi-stable display elements.

2. Related Art

Bi-stable display elements capable of displaying only two gray levels (black and white, for example) for each pixel are widespread at present. However, to improve image quality, techniques that enable individual pixels to display multiple gray levels are being developed. JP-T-2007-513368 discloses a technique that realizes a grayscale (half gray levels) in addition to black and white in an electrophoretic display device, which is one type of bi-stable display element (FIG. 1 and the like).

The technique disclosed in JP-T-2007-513368 has a problem in that it is difficult to accurately reproduce half gray levels between when displaying a half gray level partway through shifting from black to white and when displaying a half gray level partway through shifting from white to black.

### SUMMARY

An advantage of some aspects of the invention is to provide a technique for improving the reproducibility of half gray levels when carrying out a multi-gray level display, of three or more gray levels, in a bi-stable display element. Widely speaking, bi-stable display technic is growing with more and more displaying gray scale/color depth, i.e. multi-stable display technic. As already indicated, the gray levels need not be black and white. For example, one extreme optical state can be white and the other dark blue, so that the intermediate gray levels will be varying shades of blue, or one extreme optical state can be red and the other blue, so that the intermediate gray levels will be varying shades of purple.

A control apparatus according to an aspect of the invention includes an obtainment unit that obtains image data expressing an image to be displayed in a bi-stable display element that shifts an optical state from a first gray level to a second gray level when a first voltage is applied and shifts the optical state from the second gray level to the first gray level when a second voltage is applied, and a control unit that controls a driving circuit that drives the bi-stable display element so that a voltage is applied to the bi-stable display element in accordance with the image data; here, the control unit applies voltages according to voltage application patterns in a plurality of periods including a erasing period, a reset period, and a write period in order to set the optical state of the bi-stable display element to gray levels indicated by the image data, the patterns are voltage application patterns of voltages from the first voltage and the second voltage so as to cause a gray level change to occur along a loop from the second gray level, to the first gray level, and back to the second gray level in a unit period, and in the case where the gray level is a half gray level between the first gray level and the second gray level, the control unit causes the gray level to be displayed in the bi-stable display element by shifting from the first gray level to the second gray level in the write period.

According to this control apparatus, the reproducibility of half gray levels can be improved when carrying out a multi-gray level display, of three or more gray levels, in the bi-stable display element.

In this case, the erasing period may be a period that applies a voltage that sets the bi-stable display element to the second gray level at the end of the erasing period.

Furthermore, the reset period may be a period that applies a voltage that realizes 0.5 or more rotations through a loop that shifts from the second gray level, to the first gray level, and back to the second gray level.

Further still, the patterns may include patterns for a plurality of driving modes having different numbers of loops for a single gray level.

In addition, the patterns may include patterns for a plurality of driving modes including a driving mode that applies a voltage for shifting directly from the first gray level to the second gray level or directly from the second gray level to the first gray level in order to display the first gray level or the second gray level in the bi-stable display element.

In addition, a length of time of a period for shifting from the first gray level to the second gray level and a length of time of a period for shifting from the second gray level to the first gray level may be common for ail of the plurality of driving modes.

Furthermore, shifting from the first gray level to the second gray level may be slower than shifting from the second gray level to the first gray level.

The control apparatus may further include a first storage unit that stores current data indicating an image currently displayed in the bi-stable display element, a second storage unit that stores next data indicating an image to be displayed in the bi-stable display element next, a counting unit that counts a number of a unit period, among a plurality of unit periods contained in the pattern, in which the voltage application ends, and a third storage unit that stores a pre-rewrite gray level value, a post-rewrite gray level value, and a voltage application pattern corresponding to the pre-rewrite gray level value and the post-rewrite gray level value, for each of a plurality of gray level values; here, the obtainment unit may obtain the current data from the first storage unit and the next data from the second storage unit, and the control unit may control the driving circuit that drives the bi-stable display element to apply to the bi-stable display element the voltage, among voltages indicated by the plurality of patterns stored in the third storage unit, that is to be applied in a unit period corresponding to the current data and the next data obtained by the obtainment unit and the number counted by the counting unit.

An electro-optical apparatus according to an aspect of the invention includes a bi-stable display element that shifts an optical state from a first gray level to a second gray level when a first voltage is applied and shifts the optical state from the second gray level to the first gray level when a second voltage is applied, an obtainment unit that obtains image data expressing an image to be displayed in the bi-stable display element, and a control unit that controls a driving circuit that drives the bi-stable display element so that a voltage is applied to the bi-stable display element in accordance with the image data; here, the control unit applies voltages according to voltage application patterns in a plurality of periods including a erasing period, a reset period, and a write period in order to set the optical state of the bi-stable display element to gray levels indicated by the image data, the patterns are voltage application patterns of voltages from the first voltage and the second voltage so as to cause a gray level change to occur along a loop from, the second gray level, to the first gray level, and back to the second gray level in a unit period, and in the case where the gray level is a halfgray level between the first gray level and the second gray level, the control unit causes the gray level to be displayed in the bi-stable display element by shifting from the first gray level to the second gray level in the write period.

According to this electro-optical apparatus, the reproducibility of halfgray levels can be improved when carrying out a multigray level display, of three or more gray levels, in the bi-stable display element.

An electronic device according to another aspect of the invention includes the aforementioned electro-optical apparatus.

According to this electronic device, the reproducibility of half gray levels can be improved when carrying out a multi gray level display, of three or more gray levels, in the bi-stable display element.

A control method according to another aspect of the invention is a control method for an electro-optical apparatus, the method including obtaining image data expressing an image to be displayed in a bi-stable display element that shifts an optical state from a first gray level to a second gray level when a first voltage is applied and shifts the optical state from the second gray level to the first gray level when a second voltage is applied, and controlling a driving circuit that drives the bi-stable display element so that a voltage is applied to the bi-stable display element in accordance with the image data; here, voltages according to voltage application patterns in a plurality of periods including a erasing period, a reset period, and a write period are applied in order to set the optical state of the bi-stable display element to gray levels indicated by the image data, the patterns are voltage application patterns of voltages from the first voltage and the second voltage so as to cause a gray level change to occur along a loop from the second gray level, to the first gray level, and back to the second gray level in a unit period, and in the case where the gray level is a half gray level between the first gray level and the second gray level, the gray level is caused to be displayed in the bi-stable display element by shifting from the first gray level to the second gray level in the write period.

According to this control method, the reproducibility of halfgray levels can be improved when carrying out a multigray level display, of three or more gray levels, in a bi-stable display element.

### BRIEF DESCRIPTION OF THE DRAWINGS

The invention will be described with reference to the accompanying drawings, wherein like numbers reference like elements.

FIG. 1 is a diagram illustrating an example of a relationship between an applied voltage and an optical state in an EPD.

FIG. 2 is a diagram illustrating an example of driving modes used according to an embodiment.

FIG. 3 is a diagram illustrating an example of a voltage application pattern used according to an embodiment.

FIGS. 4A and 4B are diagrams illustrating an example of a driving waveform and gray level changes in an LG mode.

FIGS. 5A and 5B are diagrams illustrating an example of a driving waveform and gray level changes in an LF mode.

FIGS. 6A and 6B are diagrams illustrating an example of a driving waveform and gray level changes in an HS mode.

FIG. 7 is a diagram illustrating the configuration of an electronic device 1 according to an embodiment.

FIG. 8 is a schematic diagram illustrating the cross-sectional structure of an electro-optical panel 10.

FIG. 9 is a diagram illustrating a circuitry configuration of the electro-optical panel 10.

FIG. 10 is a diagram illustrating an analogous circuit of a pixel 14.

FIG. 11 is a diagram illustrating an example of the configuration of a controller 20.

FIG. 12 is a diagram illustrating an example of a table stored in an LUT 24.

FIG. 13 is a flowchart illustrating operations of the electronic device 1 according to an embodiment.

FIGS. 14A and 14B are diagrams illustrating an example of images displayed in the electro-optical panel 10.

### DESCRIPTION OF EXEMPLARY EMBODIMENTS

1. Principles

1-1. Outline

The principles of driving will be described first, before moving on to descriptions of specific configurations and operations of an apparatus according to an embodiment of the invention. In the example described here, an EPD (electrophoretic display) is used as an electro-optical element, where each pixel therein displays four gray levels.

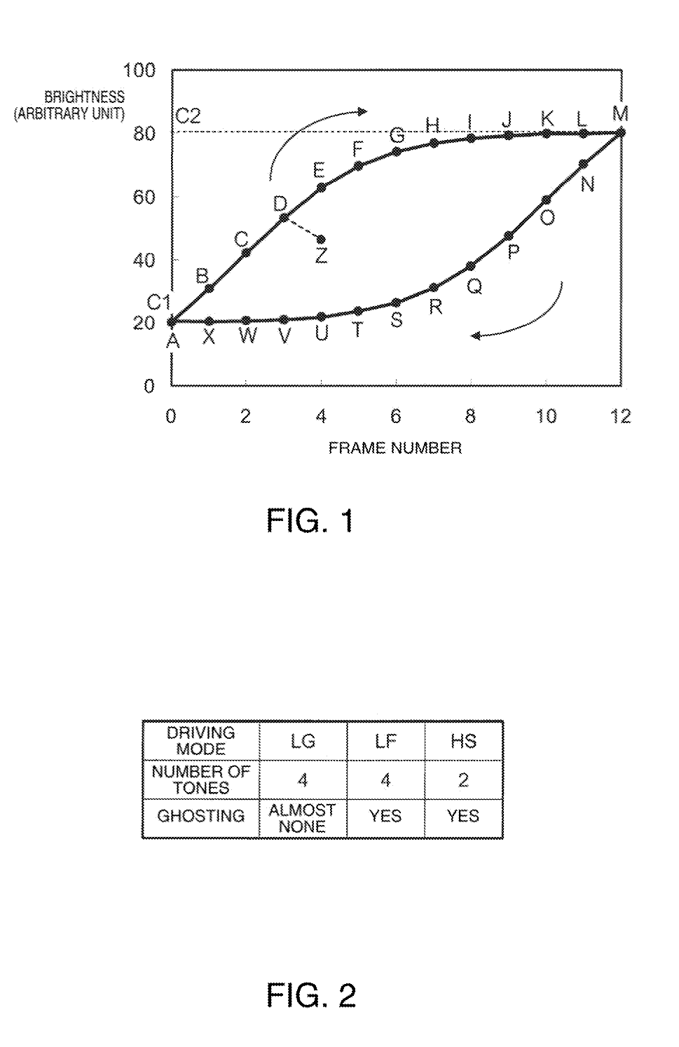

FIG. 1 is a diagram illustrating an example of a relationship between an applied voltage and an optical state in the EPD. in FIG. 1, the horizontal, axis represents the number of frames for which a voltage is applied, and the vertical axis represents an optical state of the EPD, which in this example is a brightness. “Frame” refers to a unit period for voltage application, and the length thereof is set in advance (for example, 40 ms, equivalent to 25 Hz). A brightness C1 corresponds to black (a first extreme optical state), whereas a brightness C2 corresponds to white (a second extreme optical state).

First, consider an example in which the voltage application is started at the brightness C1. A point A represents an optical state prior to the voltage application. When a predetermined first voltage (−15 V, for example) is then applied for one frame, the brightness of the EPD increases slightly to a point B. When the first voltage is then applied for another frame, the brightness of the EPD increases further to a point C. In this manner, the brightness of the EPD shifts to a point D, a point E, a point F, a point G, a point H, a point I, a point J, a point K, a point L, and a point M, in that order, as the first voltage is consecutively applied. The point M corresponds to the brightness C2, or in other words, white. Thus in this example, applying the first voltage for 12 frames shifts the brightness from black to white.

When, at the brightness C2, a predetermined second voltage (+15 V, for example) is applied for one frame, the brightness of the EPD decreases slightly to a point N. Note that for the sake of simplicity, in FIG. 1, the frame number is depicted as decreasing as the second voltage is applied. When the second voltage is then applied for another frame, the brightness of the EPD decreases further to a point O. In this manner, the brightness of the EPD shifts to a point P, a point Q, a point R, a point S, a point T, a point U, a point V, a point W, a point X, and back to the point A, in that order, as the second voltage is consecutively applied. It can be seen that the display passes through different optical states when shifting from white to black and when shifting from black to white. In other words, there is a property in which the brightness of the EPD shifts from black, to white, and then back to black in the form of a loop when the first voltage is applied for 12 frames and the second voltage is applied for 12 more frames. This loop is indicated by a solid line in FIG. 1.

Next, consider a case in which the second voltage is applied instead of the first voltage at the point D, for example. When the second voltage is applied for one frame at the point D, the brightness decreases from the point D to a point Z. The point Z is not located on the loop described above, and the brightness thereof is different from the brightness at the point C. It is difficult to predict how the brightness will shift if the first voltage or the second voltage is then applied at the point Z. Accordingly, if, when in the process of shifting from black to white, a voltage (the second voltage) that causes the shift to reverse directions (that is, to shift from, white toward black) is applied, the brightness of the EPD will not change according to the aforementioned loop thereafter, making the control, thereof difficult. Difficulties in controlling the gray level may cause problems such as difficulties in accurately reproducing half gray levels between black and white, the order of half gray levels being inverted (for example, dark gray will appear lighter than light gray), and so on.

Accordingly, in the following embodiment, when partway through a shift between two base gray levels (black and white, for example), the EPD is driven without applying a voltage that causes a shift in the reverse direction. In other words, in this embodiment, voltages are applied so as to follow the loop shown in FIG. 1. In each frame, a voltage is applied so as to cause a gray level change that corresponds to a part of the loop shown in FIG. 1.

1-2. Driving Modes

EPDs have a problem in that the response speed of the element itself is substantially slow (compared to a liquid-crystal displays and the like). If a high-quality rewrite is carried out to ensure ghosting doer not occur, an amount of time on the order of several seconds is required to rewrite a screen, approximately 10 inches in size. Although various techniques for accelerating rewrites are being developed, accelerating rewrites results in ghosting. Thus when driving an EPD, there is a tradeoff between the rewrite speed and ghosting, and it is extremely difficult to achieve driving in which rewrites occur quickly but no ghosting occurs. Accordingly, in this embodiment, three driving modes having different rewrite speeds are prepared, and different driving modes are used depending on the situation.

FIG. 2 is a diagram illustrating an example of driving modes used in this embodiment. In this embodiment, three driving modes are used, namely LG, LF, and HS. The LG (Low Ghosting) mode is a driving mode with the least amount of ghosting, or in other words, with the highest-quality rewrites, but that also has the slowest rewrite speed. The HS (High Speed) mode is a driving mode with the fastest rewrites, but that is capable of expressing only two gray levels and in which ghosting also occurs. The LF (Low Flashing) mode is an intermediate driving mode between the LG mode and the HS mode, and both the rewrite speed and the ghosting are between those of the LG mode and the HS mode.

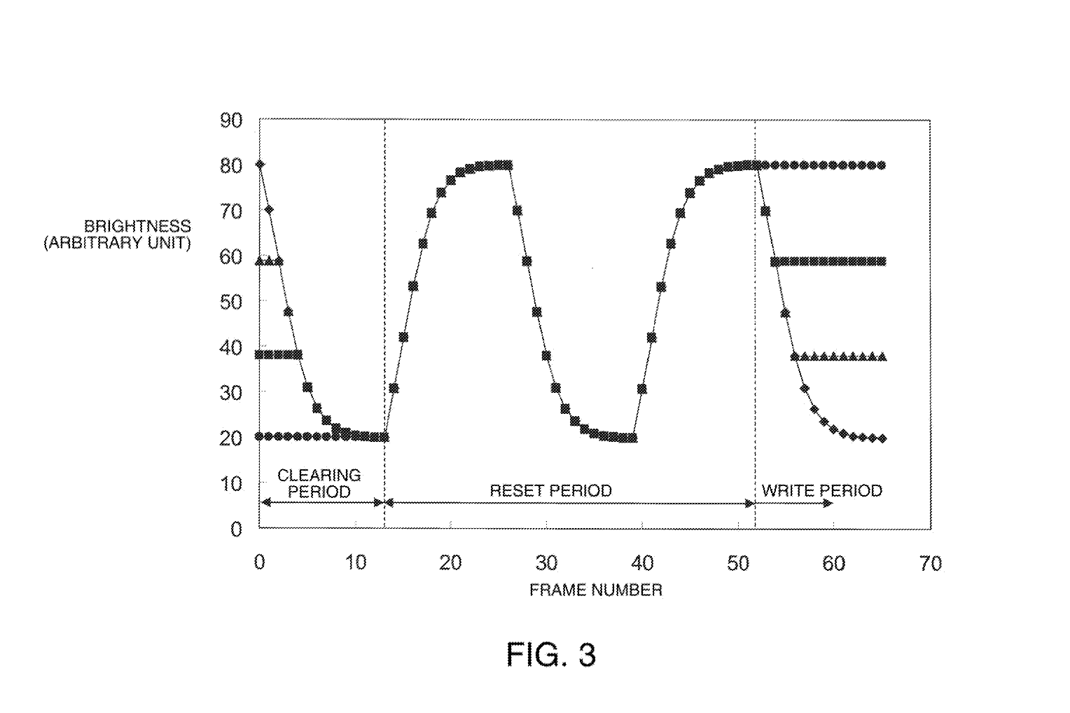

FIG. 3 is a diagram illustrating an example of a voltage application pattern used in this embodiment. In FIG. 3, the horizontal axis represents the frame number, and the vertical axis represents the brightness of the EPD. EPD driving is characterized by a voltage application pattern (sequence). The voltage application pattern indicates whether to apply a first voltage (−15 V, for example), a second voltage (+15 V, for example), or discharge (0 V) , for a predetermined number of frames. In other words, the voltage application pattern can be said to represent a change in the applied voltage over time, and in this sense, will be referred to as a “driving waveform” hereinafter.

In this embodiment, there are two parameters that determine the driving waveform, namely a current gray level and a next gray level. “Current gray level” refers to the gray level of the EPD before a rewrite. “Next gray level” refers to the gray level of the EPD after the rewrite. In FIG. 3, four points are plotted where the frame number is 0, and these points correspond to current gray levels (black, dark gray, light gray, and white). Furthermore, the waveform splits into four branches at the end of the driving waveform, and these branches correspond to the next gray levels. For example, in the case where the current gray level is light gray and the next gray level is dark gray, first and second frames discharge, the first voltage is applied in third to 12th frames, a 13th frame discharges, the second voltage is applied in 14th to 25th frames, a 26th frame discharges, the first voltage is applied in 27th to 38th frames, a 39th frame discharges, the second voltage is applied in 40 th to 51st frames, a 52nd frame discharges, the first voltage is applied in 53rd to 56th frames, and 57th to 65th frames discharge. When the driving waveform is set, the voltage applied in each frame is determined by the frame number. Accordingly, it can be said that the voltage applied, in each frame is determined by three parameters, namely the current gray level, the next gray level, and the frame number.

In this embodiment, the driving waveform is divided into a erasing period ban erasing phase), a reset period (a reset phase), and a write period (a write please). In the following, two of the gray levels displayed by the EPD that serve as base gray levels will be referred to as a first gray level and a second gray level, respectively. One of the first gray level and the second gray level corresponds to a lowest gray level, and the other corresponds to a highest gray level. In this example, white is the first gray level and black is the second gray level.

The erasing period, is a period in which the gray level of the EPD is set to a predetermined base gray level (the second gray level (black), for example). In the example shown in FIG. 3, the first to 13th frames correspond to the erasing period. The reset period is a period in which a voltage is applied so that the display rotates a predetermined number of times (at least 0.5 times) through a loop that moves from the second gray level, to the first gray level, and then back to the second gray level (from black, white, and then back to black). In addition, in this example, the reset period is a period in which a voltage is applied so as to set the gray level of the EPD to the first gray level (white) at the end of the period. In the example shown in FIG. 3, the 14th to 52nd frames correspond to the reset period (with the loop being traversed 1.5 times). The write period is a period in which the EPD is shifted to the next gray level. In the example shown in FIG. 3, the write period is a period in which, the EPD is shifted from the first gray level (white) to the next gray level.

In this example, the driving waveform is characterized by two parameters, namely a basic frame number and a gray level frame number. The basic frame number is a number of frames sufficient for enabling a shift from the first gray level (white) to the second gray level (black) and a shift from the second gray level (black) to the first gray level (white). The basic frame number does not depend on the next gray level, and is common amongst ail the driving modes. In the example shown in FIG. 3, the basic frame number is 13. Specifically, the basic frame number is a number of frames necessary to shift from one of the first gray level and the second gray level to the other (12 frames), as well as a discharge frame (one frame) that follows thereafter. The gray level frame number is a number of frames required to shift from, the first gray level (black) that serves as a base gray level, to the next gray level. The gray level frame camber differs depending on the next gray level, but is common amongst all the driving modes. In the example shown in FIG. 3, the gray level frame member is 0 in the case where the next gray level is white, the gray level frame number is 2 in the case where the next gray level is light gray, the gray level frame number is 4 in the case where the next gray level is dark gray, and the gray level frame number is 13 in the case where the next gray level is black. Note that the basic frame number and the gray level frame number change depending on driving conditions such as temperature, and thus the driving waveform is defined for each driving condition, and specifically for each temperature range.

1-2-1. LG Mode

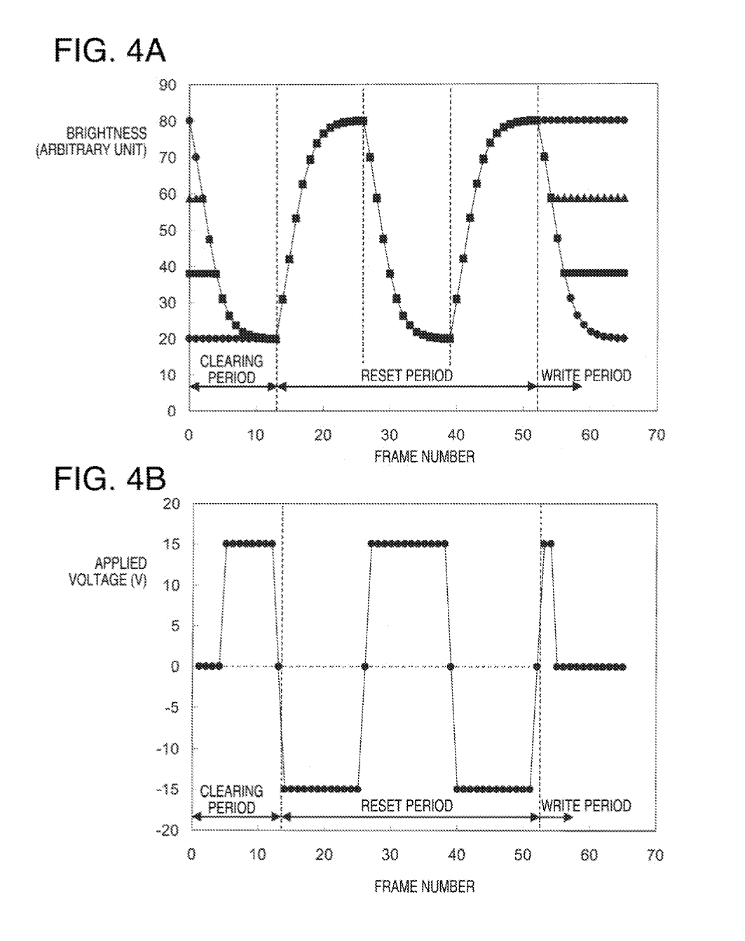

FIGS. 4A and 4B are diagrams illustrating an example of the driving waveform and gray level changes in the LG mode. FIG. AA illustrates gray level changes in the LG mode. FIG. 4B illustrates a driving waveform in the LG mode employed in the case where the current gray level and the next gray level are dark gray and light gray, respectively. In both FIGS. 4A and 4B, the horizontal axis represents the frame number. The vertical axis in FIG. 4A represents the brightness of the EPD. The vertical axis in FIG. 4B represents the applied voltage.

In order to reduce ghosting, the driving waveform in the LG mode has a characteristic in that there is a higher number of rotations through the loop in the reset period than in the LF mode and the HS mode, or to pot it more simply, the reset period is longer. In the example shown in FIGS. 4A and 4B, there are 1.5 rotations through the loop (that is, the gray level shifts from black, to white, to black, and back to white) in the reset period. When taken with the erasing period and the write period, there are 2.5 rotations through the loop when the number of rotations is the highest (that is, when the current gray level is white and the next gray level is black), and there are 1.5 rotations through the loop when the number of rotations is the lowest (that is, when the current gray level is black and the next gray level is white). In this example, the driving waveform of the LG mode is defined based on the current gray level and the next gray level each changing among four gray levels, and thus 4×4, or 16, driving waveforms are defined for a single temperature range.

1-2-2. LF Mode

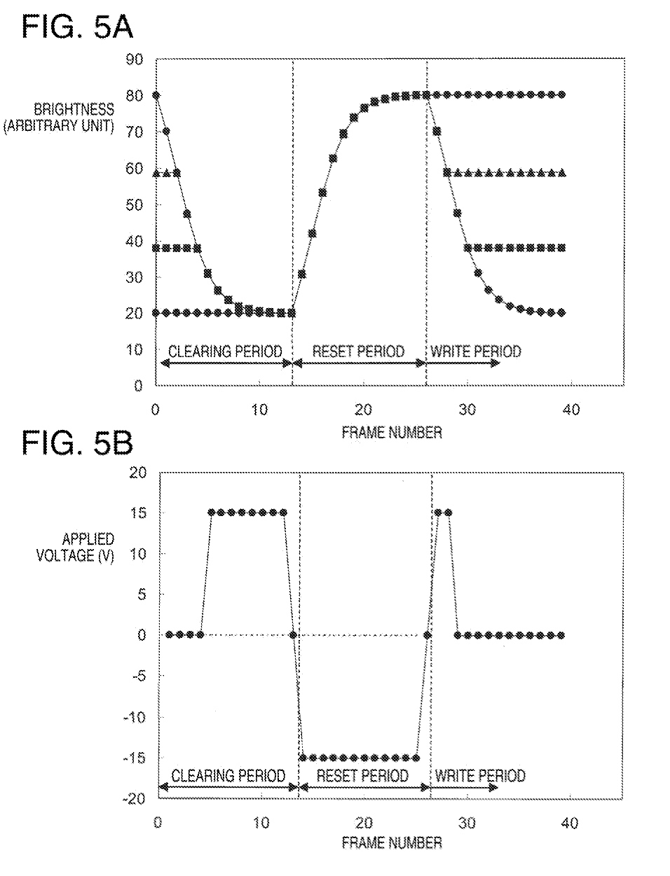

FIGS. 5A and 5B are diagrams illustrating an example of the driving waveform and gray level changes in the LF mode. FIG. 5A illustrates gray level changes in the LP mode. FIG. 5B illustrates a driving waveform in the LP mode employed in the case where the current gray level and the next gray level are dark gray and light gray, respectively. The vertical axes and horizontal axes are the same as those in FIGS. 4A and 4B.

In the LG mode, 1.5 rotations axe made through the loop in the reset period to reduce ghosting, and thus as many as 2.5 rotations through the loop are made across all the periods. This means that flashing (repeatedly changing gray levels between black and white) is carried out at a speed that is visible to a user. To the user, flashing is simply visual noise. Accordingly, the driving waveform in the LF mode has a characteristic in that the number of rotations through the loop is lower than in the LG mode in order to reduce flashing. In the example shown in FIGS. 5A and 5B, there are 0.5 rotations through the loop (that is, the gray level shifts from black to white) in the reset period. When taken with the erasing period and the write period, there are 1.5 rotations through the loop when the number of rotations is the highest (that is, when the current gray level is white and the next gray level is black), and there are 0.5 rotations through the loop when the number of rotations is the lowest (that is, when the current gray level is black and the next gray level is white). In this example, the driving waveform of the LF mode is defined based on the current gray level and the next gray level each changing among four gray levels, and thus 4×4, or 16, driving waveforms are defined for a single temperature range.

1-2-3. HS Mode

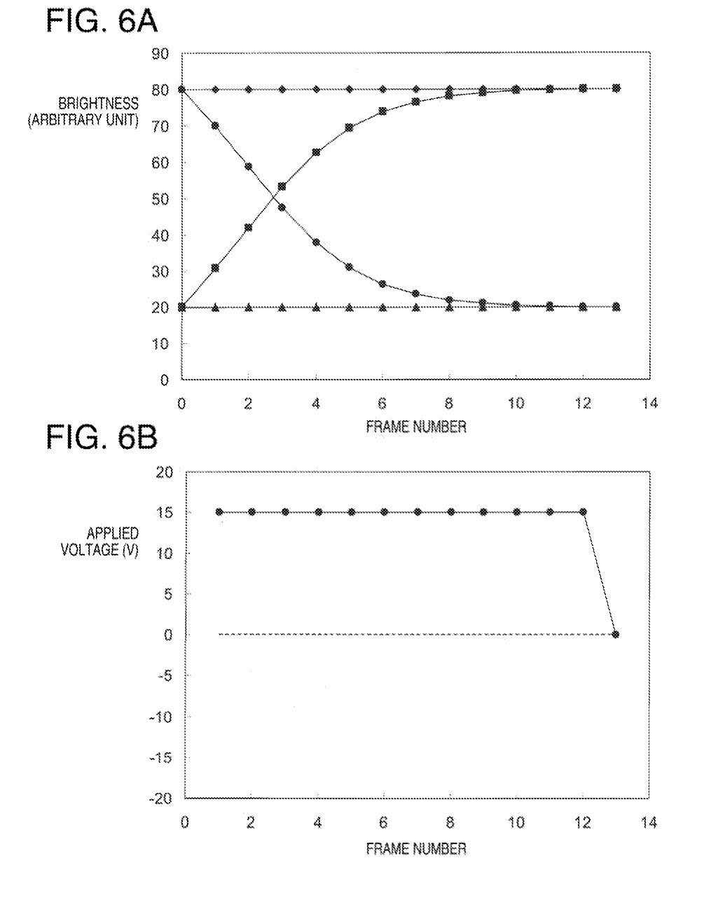

FIGS. 6A and 6B are diagrams illustrating an example of the driving waveform and gray level changes in the HS mode. FIG. 6A illustrates gray level changes in the HS mode. FIG. 6B illustrates a driving waveform in the HS mode employed in the case where the current gray level and the next gray level are white and black, respectively. The vertical aces and horizontal axes are the same as those in FIGS. 4A to 5B.

Although the LF mode has fewer rotations through the loop that in the LG mode, there are still as many as 1.5 rotations, and thus there is still room for improvement in terms of the rewrite speed. Accordingly, the HS mode has a characteristic in that the gray levels displayed are limited to two gray levels (black and white) in order to accelerate the rewrites, and the rewrites are carried out by shifting directly between the two gray levels. This “direct shift” refers to a shift corresponding to 0.5 rotations through the loop. Furthermore, the driving waveform in the HS mode has only the write period, and has neither the erasing period nor the reset period. In the HS mode, shifting to a different gray level takes 0.5 rotations through the loop in the entire driving waveform. In the case where the current gray level is the same as the next gray level, no rotation is made through the loop. In this example, the driving waveform of the HS mode is defined based on the current gray level and the next gray level each changing among two gray levels, and thus 2×2, or 4, driving waveforms are defined for a single temperature range.

2. Configuration

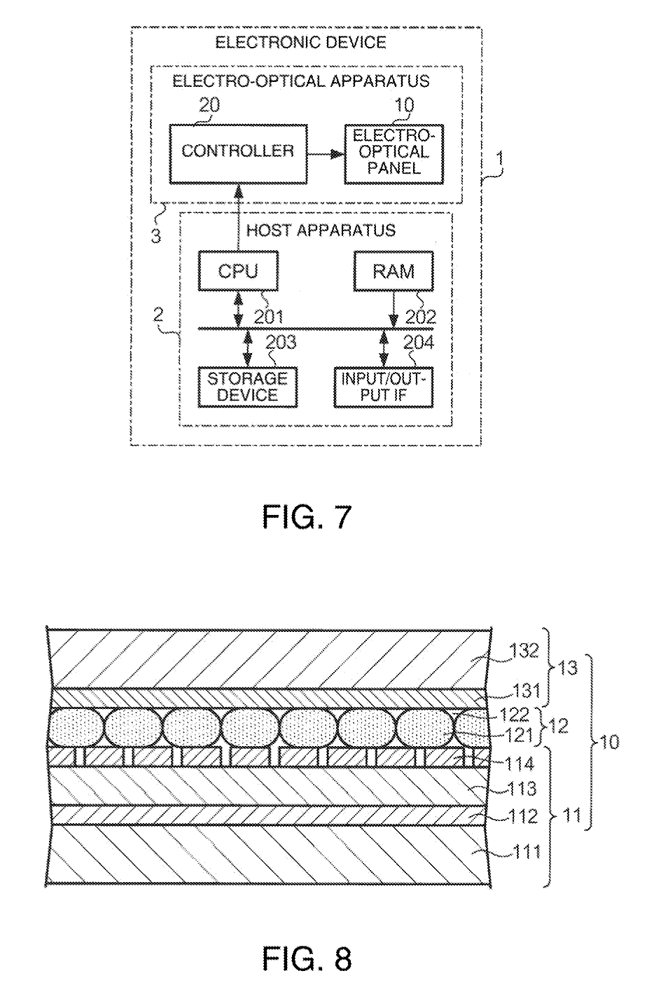

FIG. 7 is a diagram illustrating the configuration of an electronic device 1 according to this embodiment. The electronic device 1 includes a host apparatus 2 and an electro-optical apparatus 3. The electro-optical apparatus 3 is an apparatus that displays an image under the control of the host apparatus 2, and includes an electro-optical panel 10 and a controller 20. In this example, the electro-optical panel 10 is provided with a display element that uses electrophoretic particles in order to achieve a bi-stable display element in which displays are held without requiring energy to be supplied, such as through voltage applications and the like. Using this display element, the electro-optical panel 10 displays monochromatic multi-gray level images (having four gray levels, namely black, dark gray, light gray, and white, in this example). The controller 20 corresponds to a control device that controls the electro-optical panel 10. The host apparatus 2 is an apparatus that controls the electro-optical apparatus 3, and includes a CPU (central processing unit) 201, a RAM (random access memory) 202, a storage device 203, and an input/output interface 204. The CPU 201 executes programs stored in a ROM (read-only memory; not shown) or the storage device 203 using the RAM 202 as a work area. The RAM 202 is a volatile memory that stores data. The storage device 203 is a storage device that stores various types of data and application programs, and includes a non-volatile memory such as a flash memory. The input/output interface 204 is an interface for inputting or outputting data to and from various types of input devices, an output device of the electro-optical apparatus 3, or the like. The electronic device 1 is an e-book reader, a measurement device, an electronic POP device, or the like.

FIG. 8 is a schematic diagram illustrating the cross-sectional structure of the electro-optical panel 10. The electro-optical panel 10 includes a first substrate 11, an electrophoretic layer 12, and a second substrate 13, The first substrate 11 and the second substrate 13 are substrates for holding the electrophoretic layer 12 therebetween.

The first substrate 11 includes a substrate 111, an adhesive layer 112, and a circuit layer 113. The substrate 111 is formed of an insulative and flexible material, such as a polycarbonate. The substrate 111 may be formed of a resin material aside from a polycarbonate as long as the material is lightweight, flexible, elastic, and insulative. As a different example, the substrate 111 may be formed from glass, which is not flexible. The adhesive layer 112 is a layer that affixes the substrate 111 and the circuit layer 113 to each other. The circuit layer 113 is a layer that includes circuits for driving the electrophoretic layer 12. The circuit layer 113 includes pixel electrodes 114.

The electrophoretic layer 12 includes microcapsules 121 and a binder 122. The microcapsules 121 are fixed by the binder 122. A material having good compatibility with the microcapsules 121, superior adhesiveness with electrodes, and that is insulative is used as the binder 122. The microcapsules 121 are capsules that hold a carrier fluid and electrophoretic particles therein. A flexible material such as a gum Arabic/gelatin-based compound, a urethane-based compound, or the like is used for the microcapsules 121. Note that an adhesive layer formed of am adhesive may be provided between the microcapsules 121 and the pixel electrodes 114.

The electrophoretic particles are particles (high-polymers or colloids) having a property whereby the particles move within the carrier fluid under an electrical field. In this embodiment, white electrophoretic particles and black electrophoretic particles are held within each microcapsule 121. The black electrophoretic particles are particles containing a black pigment such as aniline black, carbon black, or the like, and in this embodiment, are positively charged. The white electrophoretic particles, meanwhile, are particles containing a white pigment such as titanium dioxide, aluminum oxide, or the like, and in this embodiment, are negatively charged.

The second substrate 13 includes a common electrode 131 and a film 132. The film 132 seals and protects the electrophoretic layer 12. The film 132 is formed of a transparent insulative material, such as polyethlene terephthalate. The common electrode 131 is formed of a transparent conductive material such as indium tin oxide (ITO).

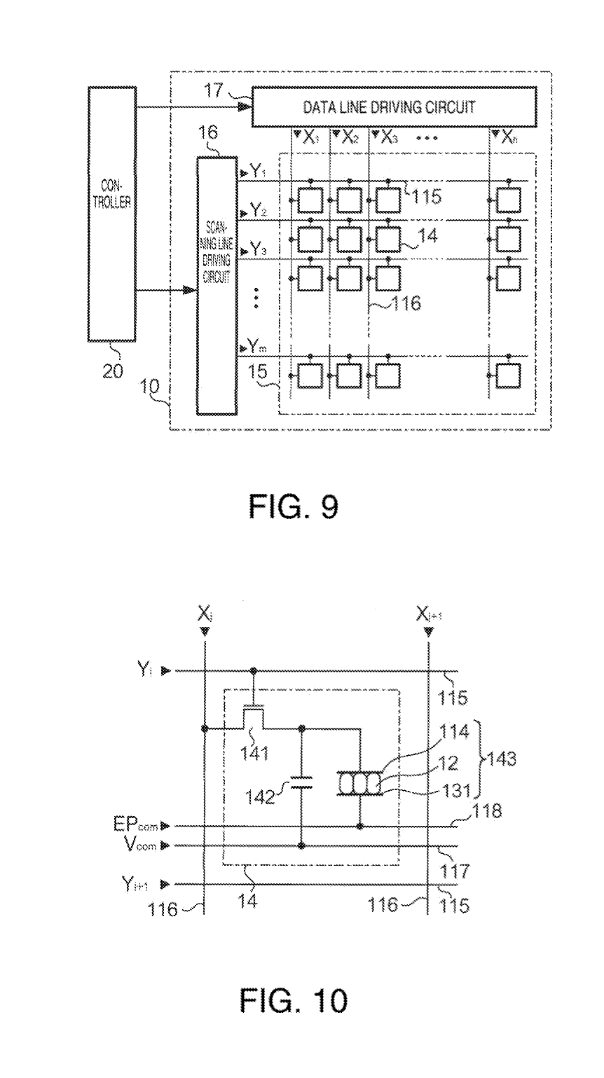

FIG. 9 is a diagram illustrating a circuitry configuration of the electro-optical panel 10. The electro-optical panel 10 includes m scanning lines 115, n data lines 116, m×n pixels 14, a scanning line driving circuit 16, and a data line driving circuit 17. The scanning line driving circuit 16 and the data line driving circuit 17 are controlled by the controller 20. The scanning lines 115 are arranged in a row direction (the x direction), and carry scanning signals. The scanning signals are signals for exclusively selecting the m scanning lines 115 one at a time in sequence. The data lines 116 are arranged in a column direction (the y direction), and carry data signals. The data signals are signals specifying the gray level of each pixel. The scanning lines 115 and the data lines 116 are insulated from each other. A pixel 14 is provided at each intersection between a scanning line 115 and a data line 116, and displays a gray level based on the data signal. Note that when it is necessary to distinguish a single scanning line 115 from the plurality of scanning lines 115, the scanning line 115 will be referred to as being in a first row, a second row, and so on up to an mth row. The same applies to the data lines 116. A display region 15 is formed by the m×n pixels 14. When it is necessary to distinguish a pixel 14 in an ith row and a jth column from the other pixels 14 in the display region 15, the pixel will be referred to as a pixel (j,i). The same applies to parameters that correspond one-to-one to the pixels 14, such as gray level values and the like.

The scanning line driving circuit 16 outputs a scanning signal Y for exclusively selecting the m scanning lines 115 one at a time in sequence. The scanning signal Y is a signal that goes to H (high) level exclusively in sequence. The data line driving circuit 17 outputs a data signal X. A data signal X is a signal specifying a data voltages based on gray level values of the pixels. The data line driving circuit 17 outputs a data signal specifying data voltages corresponding to the pixels in the row selected by the scanning signal. The scanning line driving circuit 16 and the data line driving circuit 17 are controlled by the controller 20.

FIG. 10 is a diagram illustrating an equivalent circuit of the pixel 14. The pixel 14 includes a transistor 141, a capacitor 142, and an electrophoretic element 143. The electrophoretic element 143 includes one of the pixel electrodes 114, the electrophoretic layer 12, and the common electrode 131. The transistor 141 is an example of a switching element that controls the writing of data to the pixel electrode 114, and is an n-channel TFT (thin film transistor), for example. A gate, source, and drain of the transistor 141 are connected to the scanning line 115, the data line 116, and the pixel electrode 114, respectively. When an L (low) level scanning signal (a non-selection signal) is inputted to the gate, the source and drain of the transistor 141 are insulated. When an H level scanning signal (a selection signal) is inputted to the gate, the source and drain of the transistor 141 become conductive, and the data voltage is written into the pixel electrode 114. Meanwhile, one electrode of the capacitor 142 is connected to the drain of the transistor 141, and the other electrode of the capacitor 142 is connected to a base potential Vcom via an interconnect 117. The capacitor 142 holds a charge based on the data voltage. The pixel electrodes 114 are provided one-to-one with the pixels 14, and oppose the common electrode 131. The common electrode 131 is common for all of the pixels 14, and a potential EPcom is applied thereto via an interconnect 118. The electrophoretic layer 12 is interposed between the pixel electrodes 114 and the common electrode 131. The electrophoretic element 143 is formed by the pixel electrodes 114, the electrophoretic layer 12, and the common electrode 131. A voltage corresponding to a potential difference between the pixel electrode 114 and the common electrode 131 is applied to the electrophoretic layer 12. In each microcapsule 121, the electrophoretic particles move in accordance with the voltage applied to the electrophoretic layer 12, expressing a gray level as a result. In the case where the potential of the pixel electrode 114 is positive relative to the potential EPcom of the common electrode 131 (+15 V, for example), the negatively-charged white electrophoretic particles move toward the pixel electrode 114 and the positively-charged black electrophoretic particles move toward the common electrode 131. At this time, the pixel will appear black when the electro-optical panel 10 is viewed from the side on which the second substrate 13 is located. On the other hand, in the case where the potential of the pixel electrode 114 is negative relative to the potential EPcom of the common electrode 131 (−15 V, for example), the positively-charged black electrophoretic particles move toward the pixel electrode 114 and the negatively-charged white electrophoretic particles move toward the common electrode 131. At this time, the pixel appears white.

Note that in the following descriptions, a period from when the scanning line driving circuit 16 selects the scanning line in the first row to when the scanning line driving circuit 16 finishes selecting the scanning line in the mth row will be referred to as a “frame”. The scanning lines 115 are selected one at a time in a single frame, and a data signal is supplied to each pixel 14 in a single frame.

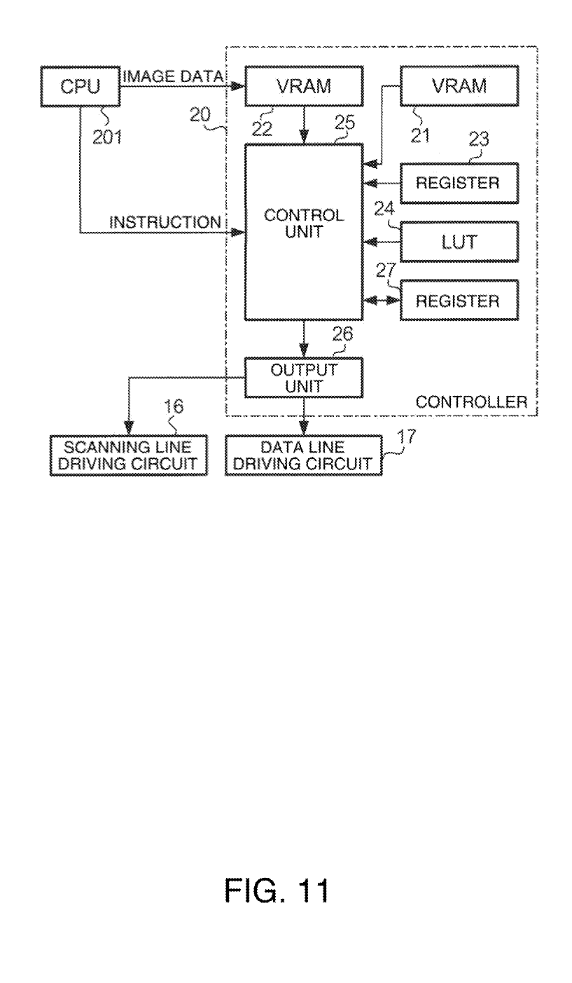

FIG. 11 is a diagram illustrating an example of the configuration of the controller 20, The controller 20 includes a VRAM 21, a VRAM 22, a register 23, an LOT 24, a control unit 25, an output unit 26, and a register 27. The VRAM 21 is a memory that stores an image displayed in the electro-optical panel 10 before a rewrite. In other words, the VRAM 21 stores data indicating the current gray levels of each of the pixels 14 in the m rows and n columns. The VRAM 22 is a memory that stores an image displayed in the electro-optical panel 10 after the rewrite. In other words, the VRAM 22 stores data indicating the next gray levels of each of the pixels 14 in the m rows and n columns. The register 23 is a register that stores parameters for specifying a frame number, or in other words, serves as a frame number counter. The LUT 24 is a table that stores information specifying the voltages to be applied in the respective frames. In this example, the LUT 24 stores tables for each of the LG mode, the LF mode, and the HS mode.

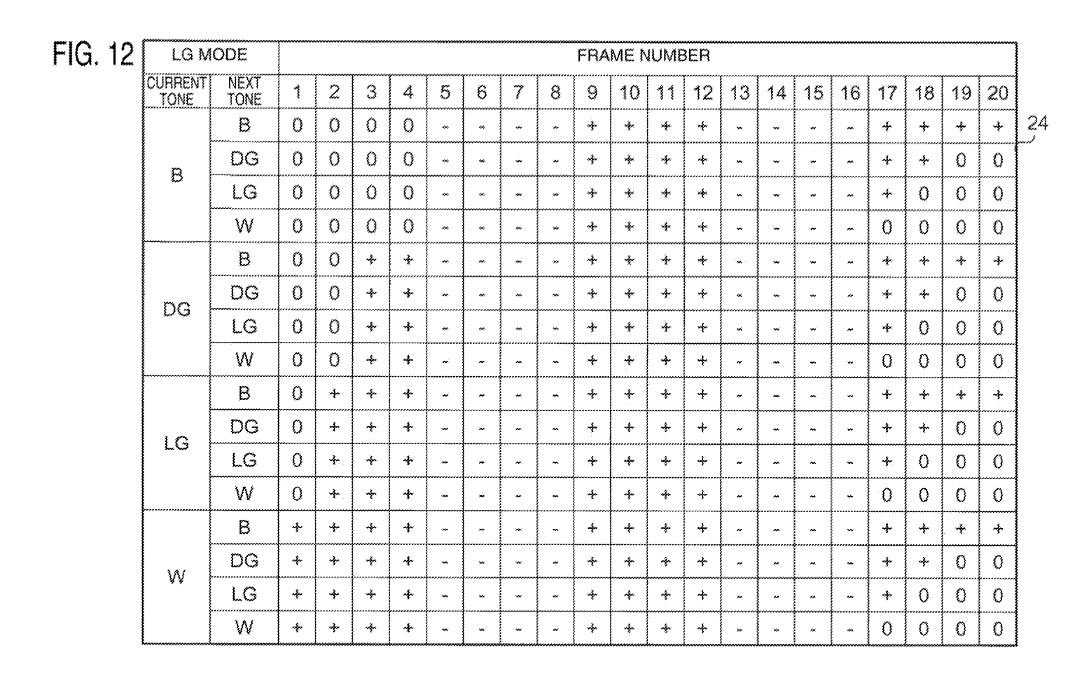

FIG. 12 is a diagram illustrating an example of (part of) a table stored in the LUT 24. Each table contains data indicating current gray levels, next gray levels, and applied voltage patterns corresponding to the current gray levels and next gray levels. In this table, black, dark gray, light gray, and white are represented by B, DG, LG, and W, respectively. In this example, the applied voltage is either “+”, “0”, or “−”. “+” and “−” indicate that a positive-polarity voltage (the second voltage) and a negative-polarity voltage (the first voltage) are applied, respectively, whereas “0” indicates that a discharge is carried out. FIG. 12 illustrates an example of a table indicating driving waveforms for the LG mode at a given temperature, among the tables stored in the LUT 24. In this example, the basic frame number is 4, and the gray level frame numbers are 4 for black, 2 for dark gray, 1 for light gray, and 0 for white. For example, in the LG mode, in the case where the current gray level and the next gray level are dark gray and light gray, respectively, the total number of frames is 17. Of these, the first to fourth frames correspond to the erasing period, the fifth to 16th frames correspond to the reset period, and the 17th frame corresponds to the write period. A discharge is carried out in the first and second frames, and the positive-polarity voltage is applied in the third and fourth frames. In the fifth to 16th frames, voltages are applied so that 1.5 rotations are made through the loop. The positive-polarity voltage is applied in the 17th frame, and the gray level of the EPD ultimately shifts to light gray. Note that a frame in which ail of the pixels are discharged at once is not provided in the example shown in FIG. 12. The discharge frame can be omitted in this manner. However, a discharge frame may of course be provided in the example shown in FIG. 12, in the same manner as the example shown in FIGS. 4A, 4B, and the like. Hereinafter, data indicating the applied voltage in each frame will be referred to as “voltage data”.

Refer again to FIG. 11. The control unit 25 generates a signal for controlling the electro-optical panel 10. To be more specific, the control unit 25 reads out, from the LUT 24, the voltage data corresponding to the driving mode, the current gray level, the next gray level, and the frame number. The control unit 25 generates the signal based on the read-out voltage data. The output unit 26 outputs the signal generated by the control unit 25. The register 27 stores an identifier indicating the driving mode to be applied when rewriting the image, from the driving modes provided in the controller 20.

The control unit 25 is an example of an obtainment unit that obtains image data expressing an image to be displayed, in a bi-stable display element (the electro-optical panel 10) and a control unit that controls a driving circuit (the scanning line driving circuit 16 and the data line driving circuit 17) that drives the bi-stable display element so that a voltage is applied to the bi-stable display element in accordance with the image data.

3. Operations

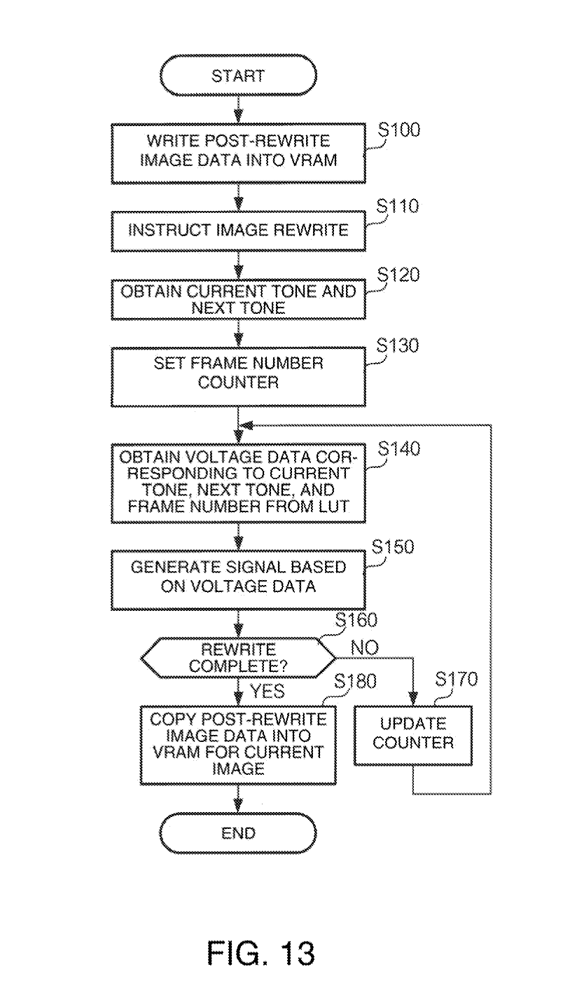

FIG. 13 is a flowchart illustrating operations of the electronic device 1 according to this embodiment. The CPU 201 of the electronic device 1 executes a program, and the flow illustrated in FIG. 12 is started upon a predetermined event occurring in execution of the program.

In step S100, the CPU 201 of the host apparatus 2 writes image data indicating a post-rewrite image into the VRAM 22. In step S110, the CPU 201 instructs the controller 20 to rewrite the image. This instruction includes an identifier indicating the driving mode no be applied in this image rewrite, from the driving modes provided in the controller 20.

Upon being instructed to rewrite the image, the control unit 25 of the controller 20 writes the identifier of the driving mode to foe applied into the register 27. In step S120, the control unit 25 obtains data indicating a pre-rewrite gray level value (the current gray level) and a post-rewrite gray level value (the next gray level) from the VRAM 21 and the VRAM 22, respectively, for the pixels to be rewritten. In step S130, the control unit 25 sets the frame number counter. Specifically, the total number of frames in the driving waveform applied in this rewrite is written into the register 23. The total number of frames in the driving waveform is obtained from the LUT 24, for example.

In step S140, the control unit 25 reads out, from the LUT 24, the voltage data corresponding to the current gray level, the next gray level, and the frame number. In step S150, the control unit 25 generates a signal based on the read-out voltage data. The output unit 26 outputs the signal generated by the control unit 25.

In step S160, the control unit 25 determines whether or not the image rewrite is complete. Whether or not the image rewrite is complete is determined using a counter value stored in the register 23. Specifically, the control unit 25 determines that the image rewrite is complete in the case where the counter value stored in the register 23 is 0. In the case where it has been determined that the image rewrite is complete (YES in S160), the control unit 25 advances the process to step S180. However, in the case where it has been determined that the image rewrite is not complete (NO in S160), the control unit 25 advances the process to step S170.

In step S170, the control unit 25 updates the counter value stored in the register 23. Specifically, the control unit 25 decrements the counter value stored in the register 23. When the counter value is updated, the control unit 25 returns the process to step S140.

In step S180, the control unit 25 copies the data stored in the VRAM 22 into the VRAM 21. As a result, the image displayed in the electro-optical panel 10 matches the data stored in the VRAM 21. Once the data has been copied, the control unit 25 ends the flow illustrated in FIG. 12. Note that although a process for changing the pixel to foe processed has not been described here, the processes of steps S120 to S180 are carried out for all of the pixels to be rewritten.

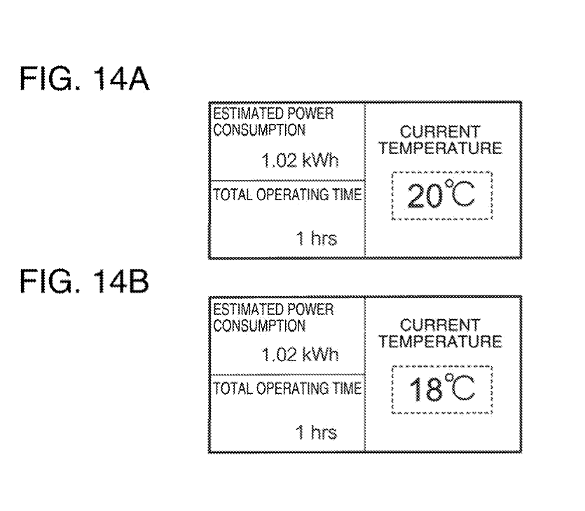

FIGS. 14A and 14B are diagrams illustrating an example of images displayed in the electro-optical panel 10. In this example, information regarding a usage state of the electronic device 1 is displayed in the electro-optical panel 10. The information regarding the usage state includes estimated power consumption, total operating time, and temperature. Of these, the temperature changes with a relatively higher frequency, whereas the estimated power consumption and the total operating time change with a relatively lower frequency. Accordingly, the CPU 201 of the host apparatus 2 instructs the controller 20 to rewrite only a region in which the temperature is displayed (in FIGS. 14A and 14B, a region, surrounded by a broken line) in the HS mode. FIG. 14A illustrates the pre-rewrite image, whereas FIG. 14B illustrates the post-rewrite image. The CPU 201 instructs the controller 20 to rewrite in the LG mode or the LF mode when a predetermined event has occurred, such as when the entire screen shown in FIGS. 14A and 14B is to be rewritten and a different image is to be displayed.

4. Variations

The invention is not limited to the aforementioned embodiment, and many variations can be made thereon. Several such variations will be described hereinafter. Note that two or more of the following variations may be used in combination with each other as well.

4-1. First Variation

The number of driving modes provided in the controller 20 is not limited to three. It is sufficient for at leasgray level of the LG mode and LF mode described in the aforementioned embodiment to be provided in the controller 20. Likewise, a different driving mode may be provided in addition to the three driving modes described in the aforementioned embodiment.

As such a different driving mode, the reset period may be omitted if the optical state changes following the arrow in the loop shown in FIG. 1 and halfgray levels are adjusted using either a shift from, the point M to the point A or a shift from the point A to the point M. For example, when shifting from the point D to the point G, the shift may go directly from the point D to the point G without passing through the point M at the brightness C2 or the point A at the brightness C1, whereas when shifting from the point G to the point D, the shift may follow the loop and arrive at the point D after passing through the point M at the brightness C2 and the point A at the brightness C1. Furthermore, a loop having the same number may be inserted for the shift from the point D to the point G and for the shift from the point G to the point D.

4-2. Second Variation

The gray level of the EPD at the end of the erasing period is not limited to the second gray level (black, in the aforementioned embodiment), The erasing period may be a period that sets the gray level of the EPD to the first gray level.

4-3. Third Variation

The numbers of rotations through the loop in the LG mode and the LF mode described in the aforementioned embodiment are merely examples, and are not limited thereto. As long as at least 0.5 rotations through the loop are made in the LF mode, a greater number of rotations may be made.

4-4. Fourth Variation

Although the aforementioned embodiment describes an example in which the basic frame number and the gray level frame number are the same in ail of the driving modes, at leasgray level of the basic frame number and the gray level frame number may be defined on a driving mode-by-driving mode basis.

4-5. Fifth Variation

Although the aforementioned embodiment describes an example in which the first gray level is white and the second gray level is black, the first gray level and the second gray level are not limited thereto. In this case, it is preferable for the shift from the first gray level to the second gray level to be slower (that is, for the response speed to be lower) than the shift from the second gray level to the first gray level. The aforementioned embodiment describes an example in which halfgray levels are reproduced using the shift from the first gray level (white) to the second gray level (black) in the write period. The halfgray levels can be adjusted with higher precision by expressing the gray levels using a shift having a low response speed. To rephrase, in the case where the response speed when a positive-polarity first voltage is applied is lower than the response speed in the case where a negative-polarity second voltage having the same absolute value as the first voltage is applied, the half gray levels are adjusted through the application of the first voltage.

4-6. Sixth Variation

The configuration of the controller 20 is not limited to the example shown in FIG. 11. For example, the VRAM 21 and the VRAM 22 may be omitted from the controller 20, and the VRAM 21 and the VRAM 22 may instead be provided outside of the controller 20. The same applies to the LUT 24, the register 23, and the register 27.

4-7. Other Variations

The equivalent circuit of the pixels 14 is not limited to the configuration described in the aforementioned embodiment. The switching element and the capacitance element may be combined in any manner as long as the configuration enables a controlled voltage to be applied between the pixel electrodes 114 and the common electrode 131. Furthermore, the method for driving the pixels may be bipolar driving, in which the electrophoretic elements 143 to which the voltages of different polarities are applied are present in a single frame, or monopolar driving, in which a voltage of the same polarity is applied to all of the electrophoretic elements 143 in a single frame.

The structure of the pixels 14 is not limited to the configuration described in the aforementioned embodiment. For example, the polarities of the charged particles are not limited to those described in the aforementioned embodiment. The black electrophoretic particles may be negatively-charged, and the white electrophoretic particles may be positively-charged. In this case, the polarities of the voltages applied to the pixels are the opposite of those described in the aforementioned embodiment. Furthermore, the display element is not limited to an electrophoretic display element that uses microcapsules. Another display element, such as a liquid-crystal element or an organic EL (electro luminescence) element, may be used instead.

The parameters described in the aforementioned embodiment (for example, the number of gray levels, the number of pixels, the voltage values, the number of voltage applications, and so on) are merely examples, and the invention is not limited thereto. For example, the EPD may have three or more gray levels.

This application claims priority from Japanese Patent Application No. 2013-041813 filed in the Japanese Patent Office on Mar. 4, 2013,the entire disclosure of which is hereby incorporated by reference in its entirely.

What is claimed is:

1. A control apparatus comprising;
an obtainment unit that obtains image data expressing an image to be displayed in a bi-stable display element that shifts an optical state from a first extreme optical state toward a second extreme optical state when a first voltage is applied and from the second extreme optical state to the first extreme optical state when a second voltage is applied; and
a control unit that controls a driving circuit that drives the bi-stable display element so that a voltage is applied to the bi-stable display element in accordance with the image data,
wherein in the case where the optical state of the bi-stable display element is to be shifted from a first gray level between the first extreme optical state and the second extreme optical state to a second gray level between the second extreme optical state and the first gray level, the control unit controls the driving circuit to apply the first voltage and cause the optical state of the bi-stable display element to shift from the first gray level to the second gray level; and
in the case where the optical state of the bi-stable display element is to be shifted from a third gray level between the first extreme optical state and the second extreme optical state to a fourth gray level between the first extreme optical state and the third gray level, the control unit controls the driving circuit to apply the first voltage and cause the optical state of the bi-stable display element to shift to the second extreme optical state, apply the second voltage and cause the optical state of the bi-stable display element to shift to the first extreme optical state, and apply the first voltage and cause the optical state of the bi-stable display element to shift from the first extreme optical state to the fourth gray level.

2. A control apparatus comprising:
an obtainment unit that obtains image data expressing an image to be displayed in a bi-stable display element that shifts an optical state from a first gray level to a second gray level when a first voltage is applied and shifts the optical state from the second gray level to the first gray level when a second voltage is applied; and
a control unit that controls a driving circuit that drives the bi-stable display element so that a voltage is applied to the bi-stable display element in accordance with the image data,
wherein the control unit applies voltages according to voltage application patterns in a plurality of periods including an erasing period, a reset period, and a write period in order to set the optical state of the bi-stable display element to gray levels indicated by the image data, the patterns are voltage application patterns of voltages from the first voltage and the second voltage so as to cause a gray level change to occur along a loop from the second gray level, to the first gray level, and back to the second gray level in a unit period, and in the case where the gray level is a half gray level, between the first gray level and the second gray level, the control unit causes the gray level to be displayed in the bi-stable display element by shifting from the first gray level to the second gray level in the write period.

3. The control apparatus according to claim 2,
wherein the erasing period is a period that applies a voltage that sets the bi-stable display element to the second gray level at the end of the erasing period.

4. The control apparatus according to claim 2,
wherein the reset period is a period that applies a voltage that realizes 0.5 or more rotations through the loop.

5. The control apparatus according to claim 4,
wherein the patterns include patterns for a plurality of driving modes having different numbers of loops for a single gray level.

6. The control device according to claim 2,
wherein the patterns include patterns for a plurality of driving modes including a driving mode that applies a voltage for shifting directly from the first gray level to the second gray level or directly from the second gray level to the first gray level in order to display the first gray level or the second gray level in the bi-stable display element.

7. The control apparatus according to claim 5,
wherein a length of time of a period for shifting from the first gray level to the second gray level and a length of time of a period for shifting from the second gray level to the first gray level are common for all of the plurality of driving modes.

8. The control apparatus according to claim 2,
wherein shifting from the first gray level to the second gray level is slower than shifting from the second, gray level to the first gray level.

9. The control apparatus according to claim 1, further comprising:
a first storage unit that stores current data indicating an image currently displayed in the hi-stable display element;
a second storage unit that stores next data indicating an image to foe displayed in the bi-stable display element nest;
a counting unit that counts a number of a unit period, among a plurality of unit periods contained in the pattern, in which the voltage application ends; and
a third storage unit that stores a pre-rewrite gray level value, a post-rewrite gray level value, and a voltage application pattern corresponding to the pre-rewrite gray level value and the post-rewrite gray level value, for each of a plurality of gray level values,
wherein, the obtainment unit obtains the current data from the first storage unit and the next data from, the second storage unit; and
the control unit controls the driving circuit that drives the bi-stable display element to apply to the bi-stable display element the voltage, among voltages indicated by the plurality of patterns stored in the third storage unit, that is to be applied in a unit period corresponding to the current data and the next data obtained by the obtainment unit and the number counted by the counting unit.

10. An electro-optical apparatus comprising the control apparatus according to claim 9.

11. A control method for an electro-optical apparatus that shifts from a first extreme optical state toward a second, extreme optical state when a first voltage is applied and shifts from the second extreme optical state toward the first extreme optical state when a second voltage having the opposite polarity as the first voltage is applied, the method comprising:
applying the first voltage and causing a shift from a first gray level between the first extreme optical state and the second extreme optical state to a second gray level between the second, extreme optical state and the first gray level in the case where an optical state is to be shifted from the first gray level to the second gray level; and
applying the first voltage and causing a shift to the second extreme optical state, applying the second voltage and causing a shift to the first extreme optical state, and applying the first voltage and causing a shift to a fourth gray level from, the first extreme optical state, in the case where the optical state is no be shifted from a third gray level between the first extreme optical state and the second extreme optical state to the fourth gray level that is between the first extreme optical state and the third gray level.
